(19) United States
(12) Patent Application Publication
(10) Pub. No.: US 2026/0262701 A1
(43) Pub. Date: Sep. 10, 2026

(54) AEROSOL-GENERATING SUBSTRATE FOR MITIGATION OF WARM AEROSOL

(71) Applicant: Philip Morris Products S.A., Neuchatel (CH)

(72) Inventors: Matteo BOLOGNA, Lausanne (CH); Gaëtan Antony COUDERC, Peseux (CH)

(73) Assignee: Philip Morris Products S.A., Neuchatel (CH)

(21) Appl. No.: 19/491,298

(22) PCT Filed: Jul. 10, 2024
(86) PCT No.: PCT/EP2024/069495

§ 371 Date: Dec. 8, 2025

(30) Foreign Application Priority Data
Jul. 11, 2023 (EP) 23184822.7

(51) Int. Cl. A24B 15/28; A24B 15/12; A24B 15/16; A24B 15/32; A24F 40/20; H05B 3/03

(52) U.S. Cl. CPC A24B 15/283; A24B 15/12; A24B 15/16; A24B 15/32; A24F 40/20; H05B 3/03

(57) ABSTRACT

A heatable aerosol-generating article for producing an inhalable aerosol is provided, the heatable aerosol generating article including: an aerosol-generating substrate including an aerosol-generating material including an aerosol former and a barrier coating, the barrier coating including a lipid, the barrier coating being provided as a layer on a surface of the aerosol-generating material, and the barrier coating being an outermost layer on the surface of the aerosol-generating material.

The present invention relates to a heated aerosol-generating article and material for use in such an article. In particular, the invention relates to an aerosol-generating material that is suitable for use in a heated aerosol-generating article, such as, for example, a “heat-not-burn” type article.

Aerosol-generating articles in which an aerosol-generating substrate, such as a tobacco-containing substrate or a nicotine-containing substrate, is heated rather than combusted, are known in the art. Typically in such heated smoking articles, an aerosol is generated by the transfer of heat from a heat source to a physically separate aerosol-generating substrate or material, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol.

A number of prior art documents disclose aerosol-generating devices for consuming or smoking heated aerosol-generating articles. Such devices include, for example, electrically heated aerosol-generating devices in which an aerosol is generated by the transfer of heat from one or more electrical heater elements of the aerosol-generating device to the aerosol-generating substrate of a heated aerosol-generating article. One advantage of such electrically heated aerosol-generating devices is that they significantly reduce sidestream smoke.

Tobacco material used as a substrate in an aerosol-generating article is commonly selected from reconstituted tobacco sheet, cast leaf and cut filler.

Reconstituted tobacco sheet and cast leaf are typically produced from the parts of the tobacco plant that are less suited for the production of cut filler, for example tobacco stems or dust. The process to form tobacco material sheets commonly comprises a step in which tobacco dust and a binder are mixed to form a slurry. The slurry is then used to create a tobacco web. For example, a tobacco web may be formed by casting a viscous slurry onto a moving metal belt to produce so called cast leaf. Alternatively, a slurry with low viscosity and high water content can be used to create reconstituted tobacco in a process that resembles paper-making.

The term “cast leaf” may be used, in particular, to denote a form of homogenised tobacco material formed by a casting process that is based on casting a slurry comprising tobacco particles (alone or in a mixture with other plant particles) and a binder (such as, for example, guar gum) onto a supportive surface, such as a belt conveyor, drying the slurry and removing the dried sheet from the supportive surface. An example of the casting or cast leaf process is described in, for example, U.S. Pat. No. 5,724,998 for making cast leaf tobacco. In a cast leaf process, particulate plant materials are produced by pulverizing, grinding, or comminuting parts of the plant. The particles produced from one or more plants are mixed with a liquid component, typically water, to form a slurry. Other components in the slurry may include additional fibres, a binder and an aerosol former. The particulate plant materials may be agglomerated in the presence of the binder. The slurry is cast onto a supportive surface and dried into a sheet of homogenised tobacco material.

The tobacco particles may be in the form of a tobacco dust comprising particles having an average diameter of the order of 30 to 80 micrometres or 100 to 250 micrometres, depending on the desired sheet thickness and casting gap. The additional fibres may include particles of tobacco stem material, stalks or other tobacco plant material, and other cellulose-based fibres such as wood fibres having a low lignin content. The type and size of the fibre particles may be selected with a view to adjusting the tensile strength of the cast leaf. Further, alternative fibres, such as vegetable fibres including hemp and bamboo may be used either with the above fibres or in alternative to the above fibres.

A suitable process for forming a sheet of reconstituted tobacco is the so-called paper-making process. In a first step of such process, a tobacco-containing material (alone or in a mixture with another plant material) is mixed with water to form a dilute suspension comprising mostly of separate cellulose fibres. This first step may involve soaking and applying heat. The suspension has a lower viscosity and a higher water content than the slurry produced in the casting process. The suspension may then be separated into an insoluble portion containing solid fibrous components and a liquid or aqueous portion comprising soluble tobacco substances. The water remaining in the insoluble fibrous portion may be drained through a screen, acting as a sieve, such that a web of randomly interwoven fibres may be laid down. Water may be further removed from this web by pressing with rollers, sometimes aided by suction or vacuum. When most of the moisture has been removed, a generally flat, uniform sheet of tobacco fibres is achieved. The soluble tobacco substances that were removed from the sheet may be concentrated, and the concentrated tobacco substances may be added back to the sheet resulting in a sheet of homogenised tobacco material. This process, as described in U.S. Pat. No. 3,860,012, has been used with tobacco to make reconstituted tobacco products, also known as tobacco paper.

Other known processes that can be applied to producing sheets of homogenised tobacco material are dough reconstitution processes of the type described in, for example, U.S. Pat. No. 3,894,544; and extrusion processes of the type described in, for example, in GB-A-983,928. Typically, the densities of homogenised tobacco materials produced by extrusion processes and dough reconstitution processes are greater than the densities of the homogenised tobacco materials produced by casting processes.

Conventionally, cut filler tobacco material is formed predominantly from the lamina portion of the tobacco leaf, which is separated from the stem portion of the leaf during a threshing process. As a way of example, to produce cut filler tobacco material, tobacco leaves are sprayed with water, steam and glycerin inside a rotary cylinder. The water and steam soften and open the leaves, while the glycerin protects the tobacco from overheating and can create aerosol when the tobacco material is consumed. The leaves are then processed in a cutter machine to produce strips up to 1 mm in width. The strips are then dried at a high temperature to reach the target humidity. After the drying process, additional “ready-to-use” tobacco components (like stems) may be added to the lamina strips. Then, for example, flavour is sprayed on the product inside a rotary chamber to give the final taste to the substrate. The product is then conveyed in a silo where it is blended to reach homogeneity. The final mix is the “cut filler”.

In other examples, the aerosol-generating material used in a substrate of an aerosol-generating article may be a material which does not contain tobacco. For example, WO 2022/074157 discloses an aerosol-forming substrate which contains hydroxypropylmethyl cellulose, a cellulose based strengthening agent and at least one aerosol former, wherein the aerosol former content is greater than 30 percent by weight. The aerosol-forming substrate may contain nicotine.

In a heated aerosol-generating article, an aerosol-generating substrate including an aerosol-generating material is heated to a relatively low temperature, for example, about 350 degrees Celsius, in order to form an inhalable aerosol. In order that an aerosol may be formed, the aerosol-generating material preferably comprises high proportions of aerosol formers and humectants, such as glycerine or propylene glycol.

To create an aerosol, aerosol formers must be released from the aerosol-generating material. In order to be released, these aerosol formers must migrate from within the body of the aerosol-generating material to surfaces of the aerosol-generating material. Other volatile compounds, such as nicotine, must also migrate from within the body of the aerosol-generating material to become entrained in the aerosol.

It is important in the field of heated aerosol-generating articles to minimise discomfort to the user during use as much as possible.

According to a first aspect of the present invention, there is provided a heated aerosol-generating article for producing an inhalable aerosol, the heated aerosol generating article comprising an aerosol-generating substrate, wherein the aerosol-generating substrate comprises an aerosol-generating material comprising an aerosol former and a barrier coating, wherein the barrier coating comprises a lipid, and the barrier coating is provided as a layer on a surface of the aerosol-generating material, preferably wherein the barrier coating is an outermost layer on the surface of the aerosol-generating material.

According to a second aspect of the present invention, there is provided an aerosol-generating material for use as an aerosol-forming substrate in a heated aerosol generating article according to the first aspect of the invention, in which the aerosol-generating material comprises an aerosol former and a barrier coating, wherein the barrier coating comprises a lipid, and the barrier coating is provided as a layer on a surface of the aerosol-generating material, preferably wherein the barrier coating is an outermost layer on the surface of the aerosol-generating material.

According to a further aspect of the invention, there is provided a method of making an aerosol-generating material according to the second aspect of the invention, wherein the method comprises the steps of: heating the barrier coating comprising the lipid above the melting point of the lipid; depositing the barrier coating as a layer on a surface of the aerosol-generating material; and solidifying the barrier coating by cooling the barrier coating below the melting point of the lipid to form a solid layer of barrier coating on the surface of the aerosol-generating material, preferably wherein the barrier coating is an outermost layer on the surface of the aerosol-generating material.

According to a yet further aspect of the invention, there is provided an aerosol generating system comprising: an aerosol-generating device comprising a heating element; and an aerosol generating article for use with the aerosol-generating device, the aerosol-generating article comprising an aerosol-generating substrate, wherein the aerosol-generating substrate comprises an aerosol-generating material comprising an aerosol former and a barrier coating, wherein the barrier coating comprises a lipid, and the barrier coating is provided as a layer on a surface of the aerosol-generating material, preferably wherein the barrier coating is an outermost layer on the surface of the aerosol-generating material.

Warm aerosol sensation is perceived by some users of heat-not-burn products. In particular warm aerosol sensation is felt by users where a heated aerosol-generating article has been exposed to humid environments, and is particularly a problem in Tropical Climate countries, due to the combination of higher temperature and higher humidity levels. It is generally thought that warm aerosol sensation occurs due to the uptake of water in the heated aerosol-generating article, and in particular, due to water absorbed by the substrate portion of the heated aerosol-generating article, which often contains hygroscopic components, for example, glycerin. The water absorbed from the external environment by the substrate portion is released in the aerosol generated after the heated aerosol-generating article is heated.

Warm aerosol sensation can be uncomfortable for the user of the heated aerosol generating article. The warm aerosol sensation can last during the pre-heating of the heated aerosol-generating article and often all along the first to third inhalations.

Thus, there is a need to mitigate warm aerosol sensation associated with heat-not-burn products.

Advantageously, the present inventors have found that providing a layer of barrier coating on a surface of the aerosol-generating material may enable the hygroscopic properties of the substrate to be modified, such that less water is absorbed by hygroscopic components in the substrate portion of the heated aerosol-generating article.

Advantageously, the barrier coating provides a protective barrier on the surface of the aerosol-generating material, such that hygroscopic components of the aerosol-generating material are prevented, at least partially, or delayed, from absorbing water from the external environment.

Advantageously, providing a barrier coating as a layer on a surface of the aerosol-generating material may enable a lower amount of aerosol former to be used in the aerosol-generating material than in prior art aerosol-generating materials. Thus, the reduced amount of aerosol former may lead to a reduction in warm aerosol sensation.

Accordingly, warm aerosol sensation may be mitigated when utilising a heated aerosol-generating article according to the present invention.

The method according to the present invention involves applying the barrier coating to the aerosol-generating substrate as a liquid. Advantageously, the method thus enables the barrier coating to easily be provided as a layer on the surface of the aerosol-generating material.

Advantageously, the method according to the present invention can allow for different methods of deposition of barrier coating on the surface of the aerosol-generating material. Thus, beneficially, the method is not limited to a specific method of deposition of the barrier coating.

Advantageously, the method according to the present invention allows direct application of the lipid as a layer on the surface of the aerosol-generating material.

Advantageously, the method may allow the barrier coating to be easily mixed with other components, for example, an aerosol former or a flavourant, prior to depositing the barrier coating on the surface of the aerosol-generating material.

The lipid may be selected from the group consisting of a fatty acid, a monoglyceride, a diglyceride, a triglyceride, and an ester of a fatty acid and a long-chain monohydric alcohol, wherein the long-chain monohydric alcohol has a chain length of from 4 to 26 carbon atoms.

Preferably, the lipid is selected from the group consisting of a monoglyceride, a diglyceride, a triglyceride, and an ester of a fatty acid and a long-chain monohydric alcohol, wherein the long-chain monohydric alcohol has a chain length of from 4 to 26 carbon atoms.

Advantageously, the lipid may be hydrophobic (for example, at least partially, hydrophobic) and therefore may form an effective barrier coating for the aerosol-generating material against the absorption of water from the external environment.

In other embodiments, the lipid may be amphiphilic, and therefore may form an effective barrier coating for the aerosol-generating material against the absorption of water from the external environment.

The melting point of the lipid may be from 40 to 100 degrees Celsius. Advantageously, the lipid may be a solid at room temperature, for example, 25 degrees Celsius, and thus may suitably form a solid protective barrier against water being absorbed by the heated-aerosol generating article, particularly against water absorbed by the aerosol-generating material if exposed to a humid environment. For example, a humid environment may be considered to be 75 percent relative humidity at 30 degrees Celsius.

Advantageously, in embodiments, a solid lipid layer also permits straightforward handling and use of the aerosol-generating article.

The lipid may be a fatty acid, preferably wherein the fatty acid has a chain length of from 13 to 18 carbon atoms. For example, the fatty acid may be palmitic acid, myristic acid or stearic acid. Preferably, the fatty acid is stearic acid.

The lipid may be a triglyceride having at least one fatty acid chain with a chain length of from 13 to 18 carbon atoms. Preferably, the triglyceride is selected from a list consisting of stearin, tripalmitin and trimyristin. Even more preferably, the triglyceride is stearin.

The barrier coating may be provided on the surface of the aerosol-generating material in an amount from 1 weight percent to 25 weight percent, based on the weight of the aerosol-generating material. Preferably, the barrier coating may be provided on the surface of the aerosol-generating material in an amount from 3 weight percent to 20 weight percent; more preferably from 6 to 18 weight percent; more preferably still from 8 to 16 weight percent; and even more preferably from 10 to 12 weight percent, based on the weight of the aerosol-generating material.

The barrier coating may comprise the lipid in an amount of up to 50 weight percent, based on the weight of the barrier coating. Preferably, the barrier coating comprises the lipid in an amount of from 1 to 45 weight percent, more preferably of from 10 to 40 weight percent, and even more preferably in an amount of from 20 to 35 weight percent, based on the weight of the barrier coating.

The barrier coating may be provided on the surface of the aerosol-generating material in a thickness of from 1 micrometre to 600 micrometres, preferably of from 5 micrometres to 550 micrometres, preferably of from 50 micrometres to 500 micrometres, preferably of from 100 micrometres to 450 micrometres, more preferably of from 150 micrometres to 400 micrometres, even more preferably of from 200 micrometres to 350 micrometres and even more preferably still of from 250 micrometres to 300 micrometres. For example, a thickness of the barrier coating is of from 1 micrometre to 600 micrometres, preferably of from 5 micrometres to 550 micrometres, preferably of from 50 micrometres to 500 micrometres, preferably of from 100 micrometres to 450 micrometres, more preferably of from 150 micrometres to 400 micrometres, even more preferably of from 200 micrometres to 350 micrometres and even more preferably still of from 250 micrometres to 300 micrometres.

Preferably, the barrier coating is not distributed within the aerosol-generating material. Preferably, there is substantially no barrier coating particles dispersed within the matrix of the aerosol-generating material. That is, preferably, there are less than 1 weight percent, more preferably less than 0.5 weight percent, and even more preferably less than 0.1 weight percent of barrier coating particles, or there are no determinable amounts of barrier coating particles, dispersed within the matrix of the aerosol-generating material.

Preferably, the barrier coating is provided as a layer on the outermost surface of the aerosol-generating material.

Preferably, the barrier coating is an outermost layer on a surface of the aerosol-generating material.

The aerosol-generating material comprises an aerosol former. The aerosol former may be any suitable known compound or mixture of compounds that, in use, facilitates formation of a dense and stable aerosol. The aerosol former may be facilitating that the aerosol is substantially resistant to thermal degradation at temperatures typically applied during use of the aerosol-generating article. Suitable aerosol formers are for example: polyhydric alcohols such as, for example, triethylene glycol, 1,3-butanediol, propylene glycol and glycerine; esters of polyhydric alcohols such as, for example, glycerol mono-, di- or triacetate; aliphatic esters of mono-, di- or polycarboxylic acids such as, for example, dimethyl dodecanedioate and dimethyl tetradecanedioate; and combinations thereof.

The aerosol former may comprise one or more of glycerine and propylene glycol. The aerosol former may consist of glycerine or propylene glycol or of a combination of glycerine and propylene glycol.

In embodiments where the aerosol-generating material according to the specification is a tobacco-containing material, such as cast leaf or cut filler, and is intended for use in an aerosol-generating substrate in a heated aerosol-generating article, the aerosol-generating material may have an aerosol-former content of from about 5 percent to about 30 percent by weight on a dry weight basis. A tobacco-containing aerosol-generating material intended for use in an electrically-operated aerosol-generating system having a heating element may preferably include an aerosol former from about 5 percent to about 20 percent of dry weight of the aerosol-generating material, for example from about 15 percent to about 20 percent of dry weight aerosol-generating material.

Typically, in examples where the aerosol-generating material is a non-tobacco-containing material, the aerosol-generating material preferably comprises a greater amount of aerosol-former than would be present in examples where the aerosol-generating material is a tobacco-containing material. In embodiments where the aerosol-generating material according to the specification is a non-tobacco-containing material and is intended for use in an aerosol-generating substrate in a heated aerosol-generating article, the aerosol-generating material may have an aerosol-former content of from about 30 percent to about 70 percent by weight on a dry weight basis. A non-tobacco-containing aerosol-generating material intended for use in an electrically-operated aerosol-generating system having a heating element may preferably include an aerosol former from about 35 percent to about 60 percent of dry weight of the aerosol-generating material, for example from about 40 percent to about 55 percent of dry weight aerosol-generating material.

For aerosol-generating materials intended for use in an electrically operated aerosol-generating system having a heating element, the aerosol former may preferably be glycerol (also known as glycerin or glycerine) or propylene glycol.

Preferably, the aerosol-former may be one or more aerosol-former selected from the list consisting of propylene glycol, triethylene glycol, 1,3-butanediol, glycerine, glycerol monoacetate, glycerol diacetate, glycerol triacetate, dimethyl dodecanedioate, and dimethyl tetradecanedioate. The aerosol-former is preferably glycerine. In other embodiments, the aerosol-former is preferably propylene glycol. In other embodiments still, the aerosol-former is a mixture of glycerine and propylene glycol.

In particular, some aerosol formers are hygroscopic materials that function as a humectant. Therefore, it is preferable to minimise the amount of aerosol former necessary in the present invention.

The aerosol-generating material may further comprise a flavourant. It should be appreciated that any flavouring compound known in the art may be used in aerosol-generating material. For example, the flavourant may be menthol or eugenol. As used herein, the term ‘menthol’ denotes the compound 2-isopropyl-5-methylcyclohexanol in any of its isomeric forms. Advantageously, including a flavourant in the aerosol-generating material may improve the taste of the aerosol delivered to the consumer from the substrate.

In some embodiments, the barrier coating further comprises a carrier compound. For example, the carrier compound may be menthol. Thus, advantageously, the carrier compound may also have flavouring properties. In other examples, the carrier compound is an aerosol former, such as those aerosol former compounds mentioned above. In other examples still, the carrier compound may be a mixture of menthol and an aerosol former. Preferably, the carrier compound is propylene glycol. Advantageously, the carrier compound can be aerosolised and serve as a carrier for substances such as nicotine and flavourants, thus improving delivery of said substances to the user.

In examples, the barrier coating may comprise the carrier compound in an amount of up to 99.5 weight percent, based on the weight of the barrier coating. Preferably, the barrier coating comprises the carrier compound in an amount of from 55 to 99 weight percent, more preferably of from 60 to 90 weight percent, and even more preferably of from 65 to 80 weight percent, based on the weight of the barrier coating.

The aerosol-generating material may comprise a tobacco-containing material. The term tobacco-containing material is used to refer to any material comprising tobacco, including, but not limited to, tobacco leaf, tobacco rib, tobacco stem, tobacco stalk, tobacco dust, expanded tobacco, reconstituted tobacco material and homogenised tobacco material. Preferably, the tobacco-containing material is selected from reconstituted tobacco sheet, cast leaf or cut filler, as described above.

In other embodiments, the aerosol-generating material may be a non-tobacco-containing material. A non-tobacco-containing material is used to refer to a material suitable for use in an aerosol-generating substrate and does not comprise tobacco. Thus, the non-tobacco-containing material is substantially free of tobacco (for example, the non-tobacco-containing material contains of from less than 1 weight percent of tobacco, preferably of from less than 0.5 weight percent of tobacco, and even more preferably of from less than 0.1 weight percent of tobacco) or does not contain any determinable amount of tobacco. In some embodiments, the non-tobacco-containing material may be a nicotine-formulation. Preferably, the nicotine-formulation is not derived from a tobacco-containing material. For example, the aerosol-generating material be a gel composition that includes nicotine, at least one gelling agent and an aerosol former. An aerosol-generating substrate comprising a non-tobacco-containing aerosol generating material may contain hydroxypropylmethyl cellulose, a cellulose based strengthening agent and at least one aerosol former, wherein the aerosol former content is greater than 30 percent by weight.

As referenced, the term “heated aerosol-generating article” refers to an aerosol-generating article for producing an aerosol comprising an aerosol-generating substrate that is intended to be heated rather than combusted in order to release volatile compounds that can form an aerosol.

As referenced, the term “aerosol-generating material” refers to a material capable of releasing upon heating volatile compounds, which can form an aerosol. The aerosol generated from aerosol-generating substrates of aerosol-generating articles described herein may be visible or invisible and may include vapours (for example, fine particles of substances, which are in a gaseous state, that are ordinarily liquid or solid at room temperature) as well as gases and liquid droplets of condensed vapours.

As referred to, the term “aerosol former” refers to a component that can be volatilized and convey a desired substance, for example, nicotine and/or flavouring, in an aerosol when the aerosol-generating material is heated above the specific volatilization temperature of the aerosol former. An aerosol former may be any suitable compound or mixture of compounds that, in use, facilitates formation of a dense and stable aerosol and is substantially resistant to thermal degradation at the operating temperature of the heated aerosol-generating article. Different aerosol formers vaporize at different temperatures. Thus, an aerosol former may be chosen based on its ability to remain stable at or around room temperature but volatize at a higher temperature, for example from 40 to 450 degrees Celsius.

As referenced, the term “lipid” refers to an organic class of compounds which are hydrophobic or amphiphilic small molecules and encompasses, but is not limited to, sterols, fat-soluble vitamins (such as vitamins A, D, E and K), a phospholipid, a fatty acid, a monoglyceride, a diglyceride, a triglyceride, and an ester of a fatty acid and a long-chain monohydric alcohol, wherein the long-chain monohydric alcohol has a chain length of from 4 to 26 carbon atoms.

The barrier coating is provided as a layer on the surface of the aerosol-generating material, which means that the barrier coating is arranged on a surface of the aerosol-generating material, such that the barrier coating is a separately distinguishable entity from the aerosol-generating material. The barrier coating is not found in or distributed within the aerosol-generating material matrix to any appreciable degree.

The term “fatty acid” is used to refer to a carboxylic acid with an aliphatic chain which may be saturated or unsaturated. A fatty acid may be a “short-chain fatty acid” having less than 6 carbon atoms in the aliphatic chain; a “medium-chain fatty acid having from 6 to 10 carbon atoms in the aliphatic chain” or a “long-chain fatty acid” having more than 10 carbon atoms in the aliphatic chain. In some embodiments of the present invention, the lipid is a long-chain fatty acid having a fatty acid chain length of from 13 to 18 carbon atoms. Examples of long-chain fatty acids having a fatty chain length of from 13 to 18 carbon atoms palmitic acid, myristic acid or stearic acid.

The term “monoglyceride” is used to refer to a molecule of glycerol linked to a fatty acid via an ester bond.

The term “diglyceride” is used to refer to a compound having two fatty acid chains bonded to a molecule of glycerol through ester bonds.

The term “triglyceride” is used to refer to an ester derived from glycerol and three fatty acid chains.

The term “long-chain monohydric alcohol” refers to an alcohol compound having one-OH group and a carbon chain having a chain length from 4 to 26 carbon atoms.

As referenced, the term “melting point” refers to the clear point or complete melting point of the lipid. This corresponds to the temperature, in degrees Celsius, at which the lipid is fully liquid and completely clear with no solid particles remaining. Many methods known in the art can be used to measure the clear point melting point of a lipid, for example, the capillary technique or Stuart SMP50 melting point apparatus.

Aerosol-generating articles according to the present invention are suitable for use in an aerosol-generating system comprising an electrically heated aerosol-generating device having an internal heater element for heating the aerosol-generating substrate. For example, aerosol generating articles according to the invention find particular application in aerosol-generating systems comprising an electrically heated aerosol-generating device having an internal heater blade which is adapted to be inserted into the rod of aerosol-generating substrate. Aerosol-generating articles of this type are described in the prior art, for example, in European patent application EP-A-0 822 670.

As referenced, the term “aerosol-generating device” refers to a device comprising a heater element that interacts with the aerosol-generating substrate of the aerosol-generating article to generate an aerosol.

The invention is defined in the claims. However, below there is provided a non-exhaustive list of non-limiting examples. Any one or more of the features of these examples may be combined with any one or more features of another example, embodiment, or aspect described herein.

EX1. A heated aerosol-generating article for producing an inhalable aerosol, the heated aerosol generating article comprising an aerosol-generating substrate, wherein the aerosol-generating substrate comprises an aerosol-generating material comprising an aerosol former and a barrier coating, wherein the barrier coating comprises a lipid, and the barrier coating is provided as a layer on the surface of the aerosol-generating material, preferably wherein the barrier coating is an outermost layer on the surface of the aerosol-generating material.

EX2. A heated aerosol-generating article according to EX1, wherein the lipid is selected from the group consisting of a fatty acid, a monoglyceride, a diglyceride, a triglyceride, and an ester of a fatty acid and a long-chain monohydric alcohol, wherein the long-chain monohydric alcohol has a chain length of from 4 to 26 carbon atoms.

EX2A. A heated aerosol-generating article according to any of examples EX1 to EX2, wherein the lipid is selected from the group consisting of a monoglyceride, a diglyceride, a triglyceride, and an ester of a fatty acid and a long-chain monohydric alcohol, wherein the long-chain monohydric alcohol has a chain length of from 4 to 26 carbon atoms.

EX3. A heated aerosol-generating article according to any of examples EX1 to EX2A, wherein the melting point of the lipid is from 40 to 100 degrees Celsius.

EX4. A heated aerosol-generating article according to any of examples EX1 to EX3, wherein the lipid is a triglyceride having at least one fatty acid chain with a chain length of from 13 to 18 carbon atoms.

EX5. A heated aerosol-generating article according to EX4, wherein triglyceride is selected from the list consisting of stearin, tripalmitin and trimyristin.

EX6. A heated aerosol-generating article according EX5 wherein the triglyceride is stearin.

EX7. A heated aerosol-generating article according to any of examples EX1 to EX3, wherein the lipid is a fatty acid.

EX8. A heated aerosol-generating article according to example EX7, wherein the fatty acid has a chain length of from 13 to 18 carbon atoms.

EX9. A heated aerosol-generating article according to any of examples EX7 to EX8, wherein the fatty acid is selected from the group consisting of palmitic acid, myristic acid or stearic acid.

EX10. A heated aerosol-generating article according to example EX9, wherein the fatty acid is stearic acid.

EX11. A heated aerosol-generating article according to any of examples EX1 to EX10 wherein the barrier coating is provided on the surface of the aerosol-generating material in an amount from 1 weight percent to 25 weight percent.

EX12. A heated aerosol-generating article according to any of examples EX1 to EX11, wherein the barrier coating is provided on the surface of the aerosol-generating article in a thickness of from 1 micrometre to 600 micrometres, preferably of from 5 micrometres to 550 micrometres, 50 micrometres to 500 micrometres, preferably of from 100 micrometres to 450 micrometres, more preferably of from 150 micrometres to 400 micrometres, even more preferably of from 200 micrometres to 350 micrometres and even more preferably still of from 250 micrometres to 300 micrometres.

EX13. A heated aerosol-generating article according to any of examples EX1 to EX12, wherein the barrier coating is not distributed within the aerosol-generating material.

EX14. A heated aerosol-generating article according to any of examples EX1 to EX13, in which the aerosol former is selected from the list consisting of propylene glycol, triethylene glycol, 1,3-butanediol, glycerine, glycerol monoacetate, glycerol diacetate, glycerol triacetate, dimethyl dodecanedioate, and dimethyl tetradecanedioate.

EX15. A heated aerosol-generating article according to any of examples EX1 to EX14, wherein the barrier coating further comprises a carrier compound.

EX16. A heated aerosol-generating article according to example EX15, wherein the carrier compound is provided in the barrier coating in an amount of up to 99.5 weight percent based on the weight of the barrier coating, preferably, in an amount of from 55 to 99 weight percent based on the weight of the barrier coating, more preferably of from 60 to 90 weight percent based on the weight of the barrier coating, and even more preferably of from 65 to 80 weight percent based on the weight of the barrier coating.

EX17. A heated aerosol-generating article according to example EX16, wherein the carrier compound is propylene glycol.

EX18. A heated aerosol-generating article according to any of examples EX1 to EX17, wherein the lipid is provided in the barrier coating in an amount of up to 50 weight percent based on the weight of the barrier coating, preferably, in an amount of from 1 to 45 weight percent based on the weight of the barrier coating, more preferably of from 10 to 40 weight percent based on the weight of the barrier coating, and even more preferably of from 20 to 35 weight percent based on the weight of the barrier coating.

EX19. A heated aerosol-generating article according to any of examples EX1 to EX18, wherein the aerosol-generating material is a tobacco-containing material.

EX20. A heated aerosol-generating material according to EX19, wherein the tobacco-containing material is selected from reconstituted tobacco sheet, cast leaf or cut filler.

EX21. A heated aerosol-generating article according to any of examples EX1 to EX18, wherein the aerosol-generating material is a non-tobacco-containing material.

EX22. A heated aerosol-generating article according to EX21, wherein the non-tobacco-containing material comprises a nicotine-formulation.

EX23. A heated aerosol-generating article according to EX22, wherein the nicotine-formulation comprises a gel composition that includes nicotine, at least one gelling agent and an aerosol former.

EX.24 A heated aerosol-generating article according to any of examples EX1 to EX18 wherein the aerosol-generating substrate comprises hydroxypropylmethyl cellulose and one or more cellulose based strengthening agents.

EX25. A heated aerosol-generating article according to any of examples EX1 to EX24 wherein the barrier coating is configured to be applied on the surface of the aerosol-generating material by spray deposition.

EX26. A heated aerosol-generating article according to any of examples EX1 to EX24, wherein the barrier coating is configured to be applied on the surface of the aerosol-generating material by brush deposition.

EX27. An aerosol-generating material for use as an aerosol-forming substrate in a heated aerosol generating article according to any of examples EX1 to EX26, in which the aerosol-generating material comprises an aerosol former and a barrier coating, wherein the barrier coating comprises a lipid, and the barrier coating is provided as a layer on the surface of the aerosol-generating material, preferably wherein the barrier coating is an outermost layer on the surface of the aerosol-generating material.

EX28. An aerosol-generating material according to example EX27, wherein the lipid is selected from the group consisting of a fatty acid, a monoglyceride, a diglyceride, a triglyceride and an ester of a fatty acid and a long-chain monohydric alcohol, wherein the long-chain monohydric alcohol has a chain length of from 4 to 26 carbon atoms.

EX28A. An aerosol-generating material according to example any of examples EX27 to EX28, wherein the lipid is selected from the group consisting of a monoglyceride, a diglyceride, a triglyceride and an ester of a fatty acid and a long-chain monohydric alcohol, wherein the long-chain monohydric alcohol has a chain length of from 4 to 26 carbon atoms.

EX29. An aerosol-generating material according to any of examples EX27 to EX28A, wherein the melting point of the lipid is from 40 to 100 degrees Celsius.

EX30. An aerosol-generating material according to any of examples EX27 to EX29, wherein the lipid is a triglyceride having at least one fatty acid chain with a chain length of from 13 to 18 carbon atoms.

EX31. An aerosol-generating material according to example EX30, wherein triglyceride is selected from the list consisting of stearin, tripalmitin and trimyristin.

EX32. An aerosol-generating material according to example EX31, wherein the triglyceride is stearin.

EX33. An aerosol-generating material according to any of examples EX27 to EX29, wherein the lipid is a fatty acid.

EX34. An aerosol-generating material according to example EX33, wherein the fatty acid has a chain length of from 13 to 18 carbon atoms.

EX35. An aerosol-generating material according to any of examples EX33 to EX34, wherein the fatty acid is selected from the group consisting of palmitic acid, myristic acid or stearic acid.

EX36. An aerosol-generating material according to example EX35, wherein the fatty acid is stearic acid.

EX37. An aerosol-generating material according to any of examples EX27 to EX36, wherein the barrier coating is provided on the surface of the aerosol-generating material in an amount from 1 weight percent to 25 weight percent.

EX38. An aerosol-generating material according to any of examples EX27 to EX37, wherein the barrier coating is provided on the surface of the aerosol-generating article in a thickness of from 1 micrometre to 600 micrometres, preferably of from 5 micrometres to 550 micrometres, 50 micrometres to 500 micrometres, preferably of from 100 micrometres to 450 micrometres, more preferably of from 150 micrometres to 400 micrometres, even more preferably of from 200 micrometres to 350 micrometres and even more preferably still of from 250 micrometres to 300 micrometres.

EX39. An aerosol-generating material according to any of examples EX27 to EX38, wherein the barrier coating is not distributed within the aerosol-generating material.

EX40. An aerosol-generating material according to any of examples EX27 to EX39, in which the aerosol former is selected from the list consisting of propylene glycol, triethylene glycol, 1,3-butanediol, glycerine, glycerol monoacetate, glycerol diacetate, glycerol triacetate, dimethyl dodecanedioate, and dimethyl tetradecanedioate.

EX41. An aerosol-generating material according to any of examples EX27 to EX40, wherein the barrier coating further comprises a carrier compound.

EX42. An aerosol-generating material according to example EX41, wherein the carrier compound is provided in the barrier coating in an amount of up to 99.5 weight percent based on the weight of the barrier coating, preferably, in an amount of from 55 to 99 weight percent based on the weight of the barrier coating, more preferably of from 60 to 90 weight percent based on the weight of the barrier coating, and even more preferably of from 65 to 80 weight percent based on the weight of the barrier coating.

EX43. An aerosol-generating material according to example EX42, wherein the carrier compound is propylene glycol.

EX44. An aerosol-generating material according to any of examples EX27 to EX43, wherein the lipid is provided in the barrier coating in an amount of up to 50 weight percent based on the weight of the barrier coating, preferably, in an amount of from 1 to 45 weight percent based on the weight of the barrier coating, more preferably of from 10 to 40 weight percent based on the weight of the barrier coating, and even more preferably of from 20 to 35 weight percent based on the weight of the barrier coating.

EX45. An aerosol-generating material according to any of examples EX27 to EX44, wherein the aerosol-generating material comprises a tobacco-containing material.

EX46. An aerosol-generating material according to example EX45, wherein the tobacco-containing material is selected from reconstituted tobacco sheet, cast leaf or cut filler.

EX47. An aerosol-generating material according to any of examples EX27 to EX44, wherein the aerosol-generating material comprises a non-tobacco-containing material.

EX48. An aerosol-generating material according to example EX47, wherein the non-tobacco-containing material comprises a nicotine-formulation.

EX49. An aerosol-generating material according to example EX48, wherein the nicotine-formulation comprises a gel composition that includes nicotine, at least one gelling agent and an aerosol former.

EX50. An aerosol-generating material according to example EX27 to EX44 wherein the aerosol-generating substrate comprises hydroxypropylmethyl cellulose and one or more cellulose based strengthening agents.

EX51. An aerosol-generating material according to any of examples EX27 to EX50 wherein the barrier coating is configured to be applied on the surface of the aerosol-generating material by spray deposition.

EX52. An aerosol-generating material according to any of examples EX27 to EX50, wherein the barrier coating is configured to be applied on the surface of the aerosol-generating material by brush deposition.

EX53. A method of making an aerosol-generating material according to any of examples

EX27 to EX52, wherein the method comprises the steps of:
heating the barrier coating comprising the lipid above the melting point of the lipid;
depositing the barrier coating as a layer on a surface of the aerosol-generating material; and
solidifying the barrier coating by cooling the barrier coating below the melting point of the lipid to form a solid layer of barrier coating on the surface of the aerosol-generating, preferably wherein the barrier coating is an outermost layer on the surface of the aerosol-generating material.

EX54. A method of making an aerosol-generating material according to example EX53 wherein after the barrier coating comprising the lipid has been heated above the melting point of the lipid, the barrier coating is mixed with an aerosol former prior to applying the barrier coating as a layer on the surface of the aerosol-generating material.

EX55. A method of making an aerosol-generating material according to any of examples EX53 to EX54, wherein after the barrier coating comprising the lipid has been heated above the melting point of the lipid, the barrier coating is mixed with a flavourant prior to applying the barrier coating as a layer on the surface of the aerosol-generating material.

EX56. A method of making an aerosol-generating material according to any of examples EX53 to EX55, wherein the lipid is selected from the group consisting of a fatty acid, a monoglyceride, a diglyceride, a triglyceride and an ester of a fatty acid and a long-chain monohydric alcohol, wherein the long-chain monohydric alcohol has a chain length of from 4 to 26 carbon atoms.

EX56A. A method of making an aerosol-generating material according to any of examples EX53 to EX56, wherein the lipid is selected from the group consisting of a monoglyceride, a diglyceride, a triglyceride and an ester of a fatty acid and a long-chain monohydric alcohol, wherein the long-chain monohydric alcohol has a chain length of from 4 to 26 carbon atoms.

EX57. A method of making an aerosol-generating material according to any of examples EX53 to EX56A, wherein the melting point of the lipid is from 40 to 100 degrees Celsius.

EX58. A method of making an aerosol-generating material according to any of examples EX53 to EX57, wherein the lipid is a triglyceride having at least one fatty acid chain with a chain length of from 13 to 18 carbon atoms.

EX59. A method of making an aerosol-generating material according to example EX58, wherein triglyceride is selected from the list consisting of stearin, tripalmitin and trimyristin.

EX60. A method of making an aerosol-generating material according to example EX59, wherein the triglyceride is stearin.

EX61. A method of making an aerosol-generating material according to any of examples EX53 to EX57, wherein the lipid is a fatty acid.

EX62. A method of making an aerosol-generating material according to example EX61, wherein the fatty acid has a chain length of from 13 to 18 carbon atoms.

EX63. A method of making an aerosol-generating material according to any of examples EX61 to EX62, wherein the fatty acid is selected from the group consisting of palmitic acid, myristic acid or stearic acid.

EX64. A method of making an aerosol-generating material according to example EX63, wherein the fatty acid is stearic acid.

EX65. A method of making an aerosol-generating material according to any of examples EX53 to EX64, wherein the barrier coating is provided on the surface of the aerosol-generating material in an amount from 1 weight percent to 25 weight percent.

EX66. A method of making an aerosol-generating material according to any of examples EX53 to EX65, wherein the barrier coating is provided on the surface of the aerosol-generating article in a thickness of from 1 micrometre to 600 micrometres, preferably of from 5 micrometres to 550 micrometres, 50 micrometres to 500 micrometres, preferably of from 100 micrometres to 450 micrometres, more preferably of from 150 micrometres to 400 micrometres, even more preferably of from 200 micrometres to 350 micrometres and even more preferably still of from 250 micrometres to 300 micrometres.

EX67. A method of making an aerosol-generating material according to any of examples EX53 to EX66, wherein the barrier coating is not distributed within the aerosol-generating material.

EX68. A method of making an aerosol-generating material according to any of examples EX53 to EX67, in which the aerosol former is selected from the list consisting of propylene glycol, triethylene glycol, 1,3-butanediol, glycerine, glycerol monoacetate, glycerol diacetate, glycerol triacetate, dimethyl dodecanedioate, and dimethyl tetradecanedioate.

EX69. A method of making an aerosol-generating material according to any of examples EX53 to EX68, wherein the barrier coating further comprises a carrier compound.

EX70. A method of making an aerosol-generating material according to any of examples EX53 to EX69, wherein the carrier compound is provided in the barrier coating in an amount of up to 99.5 weight percent based on the weight of the barrier coating, preferably, in an amount of from 55 to 99 weight percent based on the weight of the barrier coating, more preferably of from 60 to 90 weight percent based on the weight of the barrier coating, and even more preferably of from 65 to 80 weight percent based on the weight of the barrier coating.

EX71. A method of making an aerosol-generating material according to example EX70, wherein the carrier compound is propylene glycol.

EX72. A method of making an aerosol-generating material according to any of examples EX53 to EX71, wherein the lipid is provided in the barrier coating in an amount of up to 50 weight percent based on the weight of the barrier coating, preferably, in an amount of from 1 to 45 weight percent based on the weight of the barrier coating, more preferably of from 10 to 40 weight percent based on the weight of the barrier coating, and even more preferably of from 20 to 35 weight percent based on the weight of the barrier coating.

EX73. A method of making an aerosol-generating material according to any of examples EX53 to EX72, wherein the aerosol-generating material comprises a tobacco-containing material.

EX74. A method of making an aerosol-generating material according to example EX73, wherein the tobacco-containing material is selected from reconstituted tobacco sheet, cast leaf or cut filler.

EX75. A method of making an aerosol-generating material according to any of examples EX53 to EX72, wherein the aerosol-generating material comprises a non-tobacco-containing material.

EX76. A method of making an aerosol-generating material according to example EX75, wherein the non-tobacco-containing material comprises a nicotine-formulation.

EX77. A method of making an aerosol-generating material according to example EX76, wherein the nicotine-formulation comprises a gel composition that includes nicotine, at least one gelling agent and an aerosol former.

EX78. A method of making an aerosol-generating material according to any of examples EX53 to EX72 wherein the aerosol-generating substrate comprises hydroxypropylmethyl cellulose and one or more cellulose based strengthening agents.

EX79. A method of making an aerosol-generating material according to any of examples EX53 to EX78, wherein the barrier coating is configured to be applied on the surface of the aerosol-generating material by spray deposition.

EX80. A method of making an aerosol-generating material according to any of examples EX53 to EX78, wherein the barrier coating is configured to be applied on the surface of the aerosol-generating material by brush deposition.

EX81. An aerosol generating system comprising:
an aerosol-generating device comprising a heating element; and
an aerosol generating article for use with the aerosol-generating device, the aerosol-generating article comprising an aerosol-generating substrate, wherein the aerosol-generating substrate comprises an aerosol-generating material comprising an aerosol former and a barrier coating,
wherein the barrier coating comprises a lipid, and
the barrier coating is provided as a layer on the surface of the aerosol-generating material, preferably wherein the barrier coating is an outermost layer on the surface of the aerosol-generating material.

EX82. An aerosol generating system according to examples EX81, wherein the lipid is selected from the group consisting of a fatty acid, a monoglyceride, a diglyceride, a triglyceride and an ester of a fatty acid and a long-chain monohydric alcohol, wherein the long-chain monohydric alcohol has a chain length of from 4 to 26 carbon atoms.

EX82A. An aerosol generating system according to any of examples EX81 to EX82, wherein the lipid is selected from the group consisting of a monoglyceride, a diglyceride, a triglyceride and an ester of a fatty acid and a long-chain monohydric alcohol, wherein the long-chain monohydric alcohol has a chain length of from 4 to 26 carbon atoms.

EX83. An aerosol generating system according to any of examples EX81 to EX82A, wherein the melting point of the lipid is from 40 to 100 degrees Celsius.

EX84. An aerosol generating system according to any of examples EX81 to EX83, wherein the lipid is a triglyceride having at least one fatty acid chain with a chain length of from 13 to 18 carbon atoms.

EX85. An aerosol generating system according to example EX84, wherein triglyceride is selected from the list consisting of stearin, tripalmitin and trimyristin.

EX86. An aerosol generating system according to example EX85, wherein the triglyceride is stearin.

EX87. An aerosol generating system according to any of examples EX81 to EX83, wherein the lipid is a fatty acid.

EX88. An aerosol generating system according to example EX87, wherein the fatty acid has a chain length of from 13 to 18 carbon atoms.

EX89. An aerosol generating system according to any of examples EX87 to EX88, wherein the fatty acid is selected from the group consisting of palmitic acid, myristic acid or stearic acid.

EX90. An aerosol generating system according to example EX89, wherein the fatty acid is stearic acid.

EX91. An aerosol generating system according to any of examples EX81 to EX90, wherein the barrier coating is provided on the surface of the aerosol-generating material in an amount from 1 weight percent to 25 weight percent.

EX92. An aerosol generating system according to any of examples EX81 to EX90, wherein the barrier coating is provided on the surface of the aerosol-generating article in a thickness of from 1 micrometre to 600 micrometres, preferably of from 5 micrometres to 550 micrometres, 50 micrometres to 500 micrometres, preferably of from 100 micrometres to 450 micrometres, more preferably of from 150 micrometres to 400 micrometres, even more preferably of from 200 micrometres to 350 micrometres and even more preferably still of from 250 micrometres to 300 micrometres.

EX93. An aerosol generating system according to any of examples EX81 to EX92, wherein the barrier coating is not distributed within the aerosol-generating material.

EX94. An aerosol generating system according to any of examples EX81 to EX93, in which the aerosol former is selected from the list consisting of propylene glycol, triethylene glycol, 1,3-butanediol, glycerine, glycerol monoacetate, glycerol diacetate, glycerol triacetate, dimethyl dodecanedioate, and dimethyl tetradecanedioate.

EX95. An aerosol generating system according to any of examples EX81 to EX94, wherein the barrier coating further comprises a carrier compound.

EX96. An aerosol generating system according to example EX95, wherein the carrier compound is provided in the barrier coating in an amount of up to 99.5 weight percent based on the weight of the barrier coating, preferably, in an amount of from 55 to 99 weight percent based on the weight of the barrier coating, more preferably of from 60 to 90 weight percent based on the weight of the barrier coating, and even more preferably of from 65 to 80 weight percent based on the weight of the barrier coating.

EX97. An aerosol generating system according to example EX96, wherein the carrier compound is propylene glycol.

EX98. An aerosol generating system according to any of examples EX81 to EX97, wherein the lipid is provided in the barrier coating in an amount of up to 50 weight percent based on the weight of the barrier coating, preferably, in an amount of from 1 to 45 weight percent based on the weight of the barrier coating, more preferably of from 10 to 40 weight percent based on the weight of the barrier coating, and even more preferably of from 20 to 35 weight percent based on the weight of the barrier coating.

EX99. An aerosol generating system according to any of examples EX81 to EX98, wherein the aerosol-generating material comprises a tobacco-containing material.

EX100. An aerosol generating system according to example EX99, wherein the tobacco-containing material is selected from reconstituted tobacco sheet, cast leaf or cut filler.

EX101. An aerosol generating system according to any of examples EX81 to EX98, wherein the aerosol-generating material comprises a non-tobacco-containing material.

EX102. An aerosol generating system according to example EX101, wherein the non-tobacco-containing material comprises a nicotine-formulation.

EX103. An aerosol generating system according to example EX102, wherein the nicotine-formulation comprises a gel composition that includes nicotine, at least one gelling agent and an aerosol former.

EX104. An aerosol generating system according to example EX81 to EX98 wherein the aerosol-generating substrate comprises hydroxypropylmethyl cellulose and one or more cellulose based strengthening agents.

EX105. An aerosol generating system according to any of examples EX81 to EX104, wherein the barrier coating is configured to be applied on the surface of the aerosol-generating material by spray deposition.

EX106. An aerosol generating system according to any of examples EX81 to EX104, wherein the barrier coating is configured to be applied on the surface of the aerosol-generating material by brush deposition.

Examples will now be further described with reference to the figures in which:

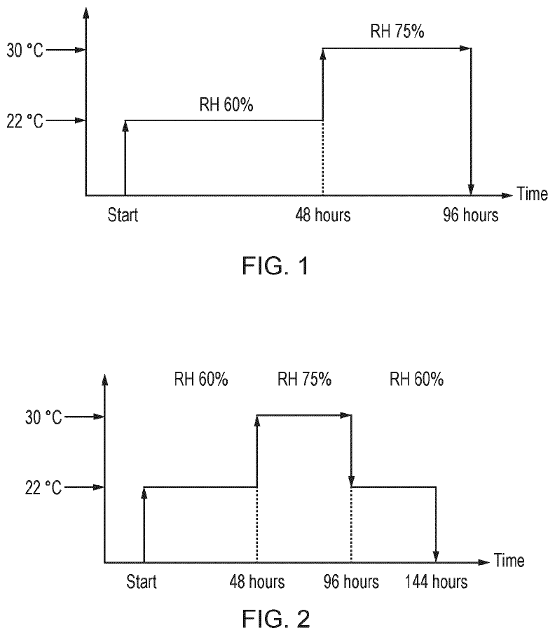

FIG. 1 depicts a first testing protocol for humidity testing of a cast leaf aerosol type generating material.

FIG. 2 depicts a second testing protocol for humidity testing of a cut-filler type aerosol generating material.

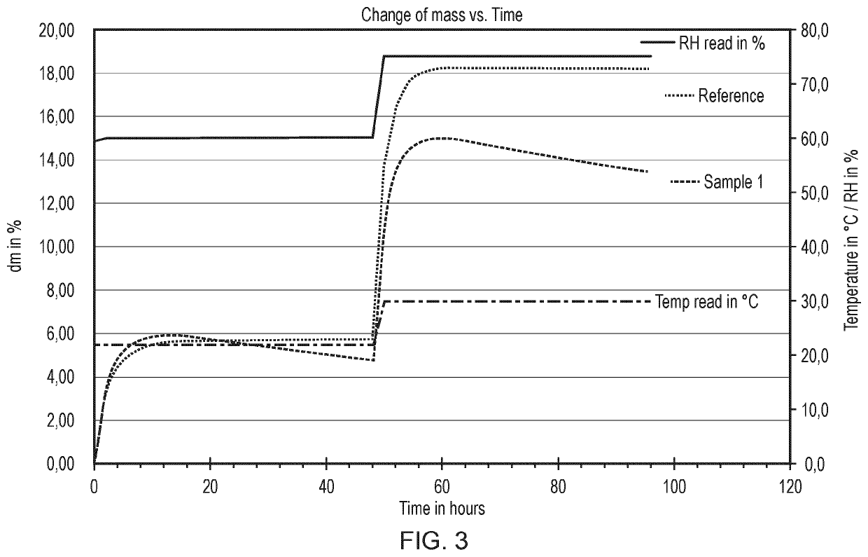

FIG. 3 is a graph showing the results of humidity testing of a cast leaf type aerosol-generating material according to the first testing protocol.

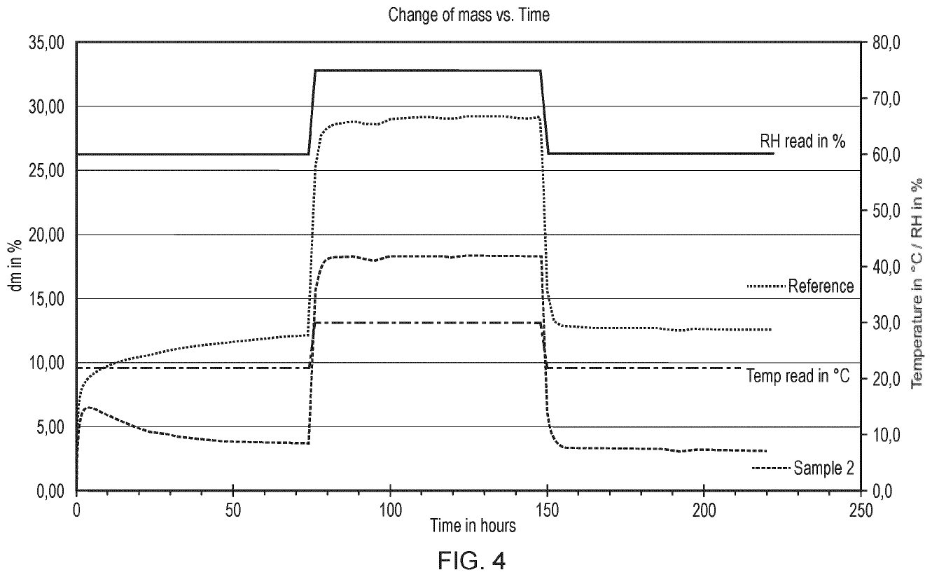

FIG. 4 is a graph showing the results of the humidity testing of a cut-filler type aerosol-generating material according to the second testing protocol.

In examples of the present invention, the present invention is not limited to a single method of depositing the barrier coating as a layer on the surface of the aerosol-generating material. For example, the barrier coating may be applied to a cast leaf type aerosol-generating material as a liquid using a brush. Therefore fundamentally, the barrier coating is “painted-on” the aerosol-generating material. Advantageously, brush deposition of the barrier coating can enable an even application of the barrier coating on the surface of the aerosol generating material.

In other embodiments, the barrier coating may be prepared as a liquid and sprayed onto the cast leaf type aerosol-generating material.

Similarly, in embodiments where the aerosol-generating material is cut filler, the barrier coating may be prepared as a liquid and sprayed-on to the cut-filler type aerosol-generating material.

### Experiment 1—Hydrophobicity Properties of the Barrier-Coating

The hydrophobicity properties of a barrier-coating applied as a layer on a surface of an aerosol-generating material were investigated and observed.

A cast-leaf type aerosol-generating material was prepared in accordance with methods known in the art.

A barrier coating solution was prepared wherein the solution contained 20 weight percent stearin in propylene glycol, based on the weight of the barrier coating solution. Approximately 10 to 20 weight percent of this solution, based on the weight of the cast leaf, was applied as a layer on a first portion, “A”, of the surface of the cast leaf using a brush deposition method, as described above.

To compare the effect of the barrier coating comprising a lipid on the modification of the water-absorption properties of the aerosol-generating material, no barrier coating was applied to the second portion, “B”, of the cast leaf aerosol-generating material. On each of portion “A” and portion “B”, a single droplet of water was deposited. The contact angle of each of the respective water droplets was then observed.

It was determined that the portion “A” of the cast leaf repelled the water droplet to a greater degree than the portion “B” of the cast leaf aerosol-generating material. This was concluded at least for the reason that the contact angle of the water droplet on the cast leaf aerosol-generating material was greater in the portion “A” of the cast leaf compared to the portion “B”.

Accordingly, it was demonstrated that providing a layer of barrier coating on the surface of the aerosol-generating material according to the present invention provides effective protection for the aerosol-generating substrate against moisture absorption.

### Experiment 2—Temperature and Humidity Testing of a Cast Leaf Aerosol-Generating Material

Samples of cast leaf type aerosol generating material were prepared for temperature and humidity testing.

A reference sample of cast leaf was prepared wherein the reference sample comprised approximately 65 percent tobacco particles and approximately 18 percent glycerine. No barrier coating was applied on the surface of the cast leaf reference sample.

Sample 1 was prepared in the same way as the reference sample. However, a barrier coating solution was prepared and applied as a layer on the surface of sample 1. The barrier coating solution comprised approximately 30 weight percent of stearin in menthol, based on the weight of the barrier coating solution.

To assess the effect of increasing temperature and humidity of the samples, the following protocol was followed.

Each sample of cast leaf was weighed to determine its initial starting weight and then placed in a temperature- and humidity-controlled environment. The samples were held at 22 degrees Celsius and a relative humidity of 60 percent for 48 hours. The mass of each sample was then measured once every two hours. After 48 hours, the temperature was increased to 30 degrees Celsius, and the relative humidity was increased to 75 percent. The mass of each sample was measured once every two hours for a further 48 hours. This protocol is represented in FIG. 1.

The results of the temperature and humidity testing are shown in Table 1 below and graphically in FIG. 3.

TABLE 1

| | 1^{st} Plateau (22 degrees | | 2^{nd} Plateau (30 degrees | |
|---|---|---|---|---|
| | Celsius, 60 percent | | Celsius, 75 percent | |
| | relative humidity) | | relative humidity) | |
| | Change in | Change in | Change in | Change in |
| | mass | mass | mass | mass |
| Sample | (percent) | (milligrams) | (percent) | (milligrams) |
| Reference | 5.7 | 15.6 | 18.2 | 49.4 |
| Sample 1 | 4.8 | 12.4 | 13.5 | 35.1 |

The results of the testing show that at 22 degrees Celsius and 60 percent relative humidity, each sample increased in mass. The reference sample, which had no layer of barrier coating on the surface of the cast leaf, experienced a greater change in mass than sample 1. For instance, the percentage mass increase of the reference sample was 5.7 percent, compared to 4.8 percent in sample 1. This effect was also observed in higher temperature and higher humidity environments. When the temperature was increased to 30 degrees Celsius and the humidity was increased to 75 percent relative humidity, the reference sample had a significantly greater percentage increase in mass, at 18.2 percent, compared to 13.5 percent in sample 1.

It is thought that the reference sample experiences a much greater increase in water uptake compared to sample 1 due to water from the environment being absorbed by hygroscopic components in the cast leaf. In sample 1, the barrier coating provides an effective protective barrier against water absorption.

Thus, it has been demonstrated that applying a barrier coating comprising a lipid to the surface of the aerosol generating material effectively limits absorption of water by the aerosol-generating material, particularly in higher temperature and humidity environments.

### Experiment 3—Temperature and Humidity Testing of Cut Filler Aerosol-Generating Material

Temperature and humidity testing was repeated with cut filler type aerosol-generating material. The testing protocol is represented in FIG. 2.

Samples of cut filler aerosol-generating material were prepared. A reference sample comprising approximately 73 percent tobacco particles and 18 percent glycerine was prepared. No layer of barrier coating was applied on the surface of the cut filler reference sample.

The cut filler of sample 2 was prepared in the same way as the reference sample. However, a barrier coating comprising 1 weight percent of stearin in menthol, based on the weight of the barrier coating, was prepared and applied as a layer on the surface of the cut filler.

The cut filler samples were weighed to determine their initial mass and then placed in a temperature- and humidity-controlled environment. The samples were held at 22 degrees Celsius and a relative humidity of 60 percent for 48 hours. The mass of each sample was then measured once every two hours. After 48 hours, the temperature was increased to 30 degrees Celsius, and the relative humidity was increased to 75 percent. The mass of each sample was measured once every two hours for another 48 hours. The temperature was then lowered to 22 degrees Celsius, and the relative humidity lowered to 60 percent, and the mass of the samples was measured once every two hours for a further 48 hours.

The results of the temperature and humidity testing of the cut filler are graphically depicted in FIG. 4 and in Table 2 below.

| | 1^{st} Plateau (22 | 2^{nd} Plateau (30 | 3^{rd} Plateau (22 |
|---|---|---|---|
| | degrees Celsius, | degrees Celsius, | degrees Celsius, |
| | 60 percent | 75 percent | 60 percent |
| | relative humidity) | relative humidity) | relative humidity) |
| | Change in mass | Change in mass | Change in mass |
| Sample | (percent) | (percent) | (percent |
| Reference | 12.1 | 29.0 | 12.9 |
| Sample 2 | 3.75 | 18.65 | 3.4 |

At 22 degrees Celsius and 60 percent relative humidity, the reference sample had a much greater increase in mass compared to sample 2, with a change in mass of 12.1 percent, compared to a change in mass of 3.75 percent for sample 2. The greater increase in mass of the reference sample can be attributed to absorption of water from the environment by hygroscopic components in the aerosol-generating material, for example, the aerosol former. The layer of barrier coating in sample 2 provides a layer of protection for the aerosol-generating material against absorption of water from the environment. This effect was also observed when the temperature and humidity was increased to 30 degrees Celsius and 75 percent relative humidity. It can be seen from the results that the percentage increase in mass of the reference sample is significantly greater than that of sample 2. The reference sample experienced an increase in mass of 29 percent, compared to 18.65 percent in sample 2.

The temperature and relative humidity percentage was then reduced to the starting values of 22 degrees Celsius and 60 percent relative humidity. The reference sample and sample 2 each decreased in mass from the mass increase experienced in the higher temperature and higher humidity conditions, when the temperature and humidity was reduced. It is thought that the cycle of relative humidity from 60 percent to 75 percent and back to 60 percent and which ends in a plateau at the initial value of the cycle, demonstrates that the barrier coating comprising a lipid, stabilizes the surface and avoids further water uptake.

Therefore, providing a barrier coating comprising a lipid as a layer on the surface of the cut filler aerosol-generating material provides an effective protective barrier against water uptake by hygroscopic components in the aerosol-generating material.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-16. (canceled)

17. A heatable aerosol-generating article for producing an inhalable aerosol, the heatable aerosol generating article comprising:
an aerosol-generating substrate comprising an aerosol-generating material comprising an aerosol former and a barrier coating,
wherein the barrier coating comprises a lipid,
wherein the barrier coating is provided as a layer on a surface of the aerosol-generating material, and
wherein the barrier coating is an outermost layer on the surface of the aerosol-generating material.

18. The heatable aerosol-generating article according to claim 17,
wherein the lipid is selected from the group consisting of a monoglyceride, a diglyceride, a triglyceride, and an ester of a fatty acid and a long-chain monohydric alcohol, and
wherein the long-chain monohydric alcohol has a chain length of from 4 carbon atoms to 26 carbon atoms.

19. The heatable aerosol-generating article according to claim 17, wherein the melting point of the lipid is from 40 degrees Celsius to 100 degrees Celsius.

20. The heatable aerosol-generating article according to claim 17, wherein the lipid is a triglyceride having at least one fatty acid chain with a chain length of from 13 carbon atoms to 18 carbon atoms.

21. The heatable aerosol-generating article according to claim 20, wherein triglyceride is selected from the list consisting of stearin, tripalmitin, and trimyristin.

22. The heatable aerosol-generating article according to claim 21, wherein the triglyceride is stearin.

23. The heatable aerosol-generating article according to claim 17, wherein the barrier coating is provided on the surface of the aerosol-generating material in an amount from 1 weight percent to 25 weight percent.

24. The heatable aerosol-generating article according to claim 17, wherein the barrier coating is provided on the surface of the aerosol-generating material in a thickness of from 1 micrometre to 600 micrometres.

25. The heatable aerosol-generating article according to claim 17, wherein the barrier coating is not distributed within the aerosol-generating material.

26. The heatable aerosol-generating article according to claim 17, wherein the aerosol former is selected from the list consisting of propylene glycol, triethylene glycol, 1,3-butanediol, glycerine, glycerol monoacetate, glycerol diacetate, glycerol triacetate, dimethyl dodecanedioate, and dimethyl tetradecanedioate.

27. The heatable aerosol-generating article according to claim 17, wherein the aerosol-generating material further comprises a tobacco-containing material.

28. The heatable aerosol-generating article according to claim 27, wherein the tobacco-containing material is selected from reconstituted tobacco sheet, cast leaf, or cut filler.

29. The heatable aerosol-generating article according to claim 17, wherein the aerosol-generating material further comprises a nontobacco-containing material.

30. An aerosol-generating material for an aerosol-forming substrate in a heatable aerosol generating article, the aerosol-generating material comprising:
an aerosol former and a barrier coating,
wherein the barrier coating comprises a lipid,
wherein the barrier coating is provided as a layer on a surface of the aerosol-generating material, and
wherein the barrier coating is an outermost layer on the surface of the aerosol-generating material.

31. A method of making the aerosol-generating material according to claim 30, the method comprising the steps of:
heating the barrier coating comprising the lipid above a melting point of the lipid;
depositing the barrier coating as a layer on the surface of the aerosol-generating material; and
solidifying the barrier coating by cooling the barrier coating below the melting point of the lipid to form a solid layer of barrier coating on the surface of the aerosol-generating material,
wherein the barrier coating is the outermost layer on the surface of the aerosol-generating material.

32. An aerosol generating system, comprising:
an aerosol-generating device comprising a heating element; and
an aerosol generating article for the aerosol-generating device, the aerosol-generating article comprising an aerosol-generating substrate,
wherein the aerosol-generating substrate comprises an aerosol-generating material comprising an aerosol former and a barrier coating,
wherein the barrier coating comprises a lipid,
wherein the barrier coating is provided as a layer on a surface of the aerosol-generating material, and
wherein the barrier coating is an outermost layer on the surface of the aerosol-generating material.
